(19) United States
(12) Patent Application Publication
(10) Pub. No.: US 2010/0169339 A1
(43) Pub. Date: Jul. 1, 2010

(54) SYSTEM, METHOD, OR APPARATUS FOR UPDATING STORED SEARCH RESULT VALUES

(75) Inventors: Flavio Junqueira, Barcelona (ES); Hugo Zaragoza, Barcelona (ES)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., a Delaware corporation, Sunnyvale, CA (US)

(21) Appl. No.: 12/346,684

(22) Filed: Dec. 30, 2008

(51) Int. Cl. G06F 7/06; G06F 17/30

(52) U.S. Cl. 707/758; 707/E17.014

(57) ABSTRACT

Embodiments of methods, apparatuses, devices and systems associated with updating stored internet search query result values are disclosed.

### FIELD

Embodiments relate to the field of search results, and more specifically to search results generated at least in part in response to one or more search queries.

### BACKGROUND

With the vast quantities of information available on the internet, it may be desirable to provide one or more methods, apparatuses, or the like at least in part to find relevant or useful information for one or more users. For example, a user may want to use a search engine to locate information relating to one or more topics. In this example, a user may use a web browser to access a search engine and submit a user query to the search engine. In an embodiment, the search engine may process the query and provide a user with search results. Accordingly, it may be desirable to improve one or more aspects of a search engines performance.

### BRIEF DESCRIPTION OF DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description when read with the accompanying drawings in which:

FIG. 1 is a schematic diagram of an embodiment, such as a system for providing search results to a user;

FIG. 2 is a schematic diagram of another embodiment, such as a computing platform;

FIG. 3 is a schematic diagram of a method or process in accordance with an embodiment.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, procedures, components or circuits that would be known by one of ordinary skill have not been described in detail so as not to obscure claimed subject matter.

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

A search engine computing platform may be useful for providing a user with one or more search results at least in response to a user submitting a query to the search engine, such as by employing a web browser in communication with a search engine computing platform via a network. In addition, under some circumstances it may be desirable for a search engine to store signal values corresponding to one or more user search queries, such as storing those signals in a memory cache, for example. In this example, a search engine platform may return cached results to a user submitting a corresponding user query rather than re-executing a user query that has already been stored in the memory cache. For example, if a user submits a search query a search engine platform may determine if corresponding search results have been saved in the memory cache. If search results corresponding to the submitted user query have been stored in the memory cache then the search engine platform may transmit signals corresponding to the cached results to a user. If, however, search results corresponding to the submitted user query have not been stored in the memory cache then the search engine platform may execute the user query and transmit signals corresponding to any generated search results to a user via a network.

In the foregoing example, it may be advantageous to update cached search results from time to time. For example, search result rankings may change over time and it may be advantageous to update cached search results to reflect changes in search result rankings from time to time. In an embodiment, requests to update cached search results may often be treated in a substantially similar manner to user submitted search queries. For example, such offline search query processing may be subject to similar limitations, such as, time, processor resources, or memory resources, as might on-line search query processing corresponding to one or more user search queries. In this embodiment, cached search results from offline search query processing may accordingly be substantially the same as search results from online search query processing generated in response to a user search query. As used herein, an “offline search query processing” request may refer to any search query processing request not initiated at least partially in response to an online search query process request. For example, an offline search query processing request may be generated by one or more computing platform at least in part to update one or more cached search results. As used herein, an “online search query processing” request may refer to a search query processing request initiated at least in part in response to a user initiated search query. For example, an online search query processing request may be initiated in response to a user submitting a search query to a search engine platform in one of the manners described above.

In at least one embodiment, a search engine platform may be implemented to handle requests to update cached search results in a different manner than user search queries. In this example, an offline search query processing request to update cached search results may be subjected to different time, processor resources, or memory resources than online search query processing of user search queries. In an example, one or more machine-learning models may provide more relevant results, but may take more time to generate and return search results to a user. In an embodiment, such machine-learning models may be employed for offline search query processing and cached for later use in connection with online search query processing without increasing latency of online query processing. For another example, offline search query processing requests to update cached search results may be allowed to execute on a search engine platform for a longer period of time that online search query processing requests at least in part to generate more refined search results. In this example, cached search results may be more relevant than search results generated in response to a user search query. In one embodiment, offline search query processing requests to update cached search results may be placed in a separate queue than online search query processing requests corresponding to user search queries and processed differently as discussed above. In another embodiment, offline search query processing requests to update cached search results may be transmitted to a separate search engine platform for execution as discussed above. It should, however, be noted that these are merely illustrative examples relating to updating cached search results and that claimed subject matter is not limited in this regard.

For another example, search engines may use one or more approximations to speed-up computation of a particular document's relevance to a particular search query. In this example, a search engine may employ one or more of the following techniques; consider only documents which contain all the words in a particular search query and disregarding documents that do not contain all the words of that particular search query; or use a relatively simple (fast) ranking function to eliminate many documents quickly and then use a relatively more accurate (and slow) ranking function to compute a relevance of the most promising documents. Since these approximations speed up the retrieval process at the cost of degrading the quality of results, a search engine may improve search results for offline user queries by not using the above approximations. For example, instead of only considering documents that match all terms of a particular search query a search engine may consider and rank any documents at least partially matching the query, such as any documents matching a threshold number of search terms. For further example, a search engine may process offline search queries using a relatively slow but more accurate ranking function for any documents that may match a particular search query. It should, however, be noted that these are merely illustrative examples relating to search query processing and claimed subject matter is not limited in this regard.

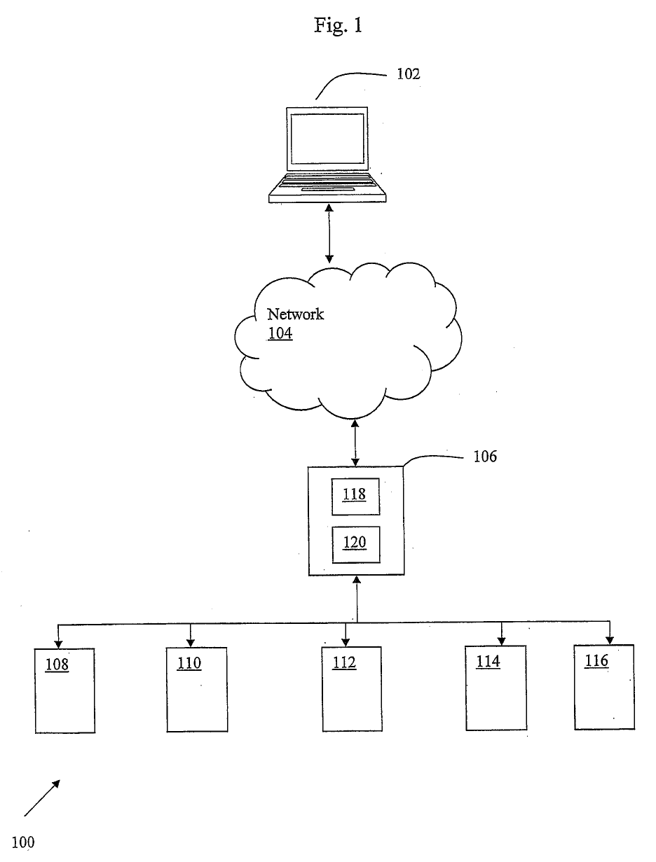

FIG. 1 is a schematic diagram of an embodiment 100, such as a system for providing search results to a user. With regard to FIG. 1, a user, such as by employing a computing platform 102 may access a search engine such as with an application program. For example, a user may use a web browser executing on computing platform 102 to access a search engine via network 104. In this example a user may enter one or more queries into the web browser. At least in response to a user input, one or more signals corresponding to the user query may be transmitted via network 104 to a search engine platform such as search engine platform 106, for example. As used herein, search queries, online search queries, offline search queries, search results, cached search results, or the like may correspond to one or more signals or signal values. In an embodiment, search engine platform 106 may process the one or more signals transmitted from computing platform 102. For example, search engine platform 106 may parse the search query corresponding to the one or more signals at least in part to determine one or more aspects of the online search query. In an embodiment, search engine platform 106 may determine if the online search query has one or more corresponding search results stored in a memory cache, such as one or more memory devices or data structures coupled to search engine platform 106. In this example, if the online search query has one or more corresponding results stored in the memory cache search engine platform may transmit the cached search results to computing platform 102 via network 104 at least in part so that the cached search results may be displayed to the user.

If, however, the online search query does not have corresponding cached search results then search engine platform may process the corresponding signals further for execution of the online search query. For example, search engine platform 106 may execute the online search query itself and transmit the search results to computing platform 102 via network 104. In another embodiment, search engine platform may search among additional search engine platforms, such as search engine platforms 108, 110, 112, 114, or 116. For example, search engine platform 106 may determine which if any of the other search engine platforms are available for executing the user search query. In this example, search engine platform 106 may transmit the online search query to an available search engine platform for execution. In addition, search engine platform 106 may receive one or more search results from one of the search engine platforms and transmit those search results to computing platform 102 via network 104. In yet another embodiment, search engine platform 106 may transmit the online search query to one or more of the other search engine platforms. In this example, the other search engine platforms may be assigned to search particular respective portions of available internet content. The other search engine platforms may transmit their respective search results to search engine platform 106. In this example, search engine platform 106 may assemble or rank one or more search results transmitted from the other search engine platforms and transmit the assembled search results to computing platform 102 via network 104. It should, however, be noted that these are merely illustrative examples relating to user queries or search engine results and that claimed subject matter is not limited in this regard.

In an embodiment it may be desirable for search engine platform 106 to update one or more of the cached search results. For example, it may be desirable to update cached search results from time to time to adjust for changes in available content or to reflect new content available that may correspond to a user search query. In this embodiment, search engine platform 106 may process an offline search query request to update cached search results. For example, search engine platform 106 may execute an offline search query corresponding to the cached results at least in part to generate updated search results and store the updated search results in the memory cache for subsequent use. In addition, as described above search engine platform 106 may employ additional search engine platforms, such as search engine platforms 108, 110, 112,114, or 116 such as in any of the manners described above, to generate updated search results corresponding to the cached search results and store the updated search results in the memory cache. It should, however, be noted that these are merely illustrative examples relating to updating cached search results and claimed subject matter is not limited in these regards.

In an embodiment, search engine platform 106 may, under some circumstances, handle offline search query processing requests in a manner different than online search query processing requests corresponding to a user search query. For example, online search query processing requests may be subject to limitations relating to amount of time for generating search results, processing resources for generating search results, memory resources for generating search results, or the like. In this example, offline search query processing requests to update cached search results may be subject to different limitations, such as more time, processing resources, memory resources, of the like for generating search results. In an embodiment, offline search query processing requests to update cached search results may employ the same or similar ranking processes as those used of user search requests. However, such a ranking process may be allowed to execute for a longer timer period with requests to update cached search results allowing for, under appropriate circumstances, improved search results stored in cache. In another embodiment, more complex algorithms may be used to process offline search query processing requests to update cached search results at least in part to generate more refined search results. It should, however, be noted that these are merely examples relating to updating cached search results and generating user search results and that claimed subject matter is not limited in this regard.

In an embodiment, search engine platform 106 may employ any of a number of processes at least in part to differentiate between offline search query processing requests to update cached search results and online search query processing requests corresponding to user search queries. In one example, search engine platform 106 may employ a first queue 118 for requests to update cached search results and a second queue 120 for user search queries. In this example, online search query processing requests corresponding to user search queries may be executed at a higher priority due to desirable time constraints on such queries. On the other hand, offline search query processing requests to update cached search results may be executed when processing resources are available for more in depth processing of such requests. In this embodiment, search engine platform 106 may parse one or more received queries at least in part to determine if such queries are online search query processing requests or offline search query processing requests. Once a query type is determined, search engine platform 106 may assign a received query to an appropriate one of queue 118 or queue 120. In yet another embodiment, search engine platform 106 may alternatively employ different additional search engine platforms for executing online search query processing requests corresponding to user search queries than for executing offline search query processing requests to update cached search results. For example, search engine platform 106 may assign offline search query processing requests to search engine platforms 108 and 110 for execution while assigning online search query processing requests to search engine platforms 112, 114, and 116 for execution. In this example, updated search results may be transmitted to search engine platform 106 and stored in a memory cache. Also in this example, user search results may be transmitted to search engine platform 106 for subsequent transmission to computing platform 102 via network 104. It should, however, be noted that these are merely illustrative examples relating to processing requests to update cached search results and generate user search results and that claimed subject matter is not limited in this regard.

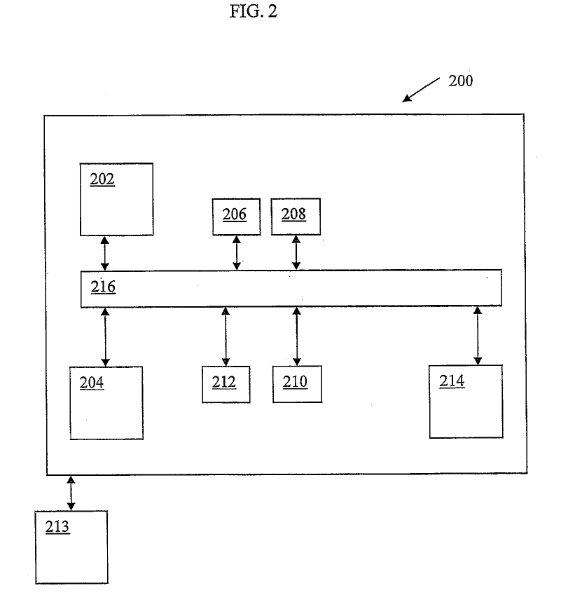

FIG. 2 is a schematic diagram of a computing platform, such as a search engine platform, in accordance with an embodiment 200. With regard to FIG. 2, embodiment 200 may comprise one or more processors, such as processor 202. Furthermore, embodiment 200 may comprise one or more memory devices, such as storage device 204, memory units 206 and 208, search query queues 210 and 212, or computer readable medium 213. In addition, embodiment 200 may comprise one or more network communication adapters, such as network communication adaptor 214. Embodiment 200 may also comprise a communication bus, such as communication bus 216, operable to allow one or more connected components to communicate under appropriate circumstances. In an embodiment, communication adapter 214 may be operable to receive one or more search query processing requests, such as one or more online search query processing requests or one or more online search query processing requests. In addition, communication adapter 214 may be operable to send or receive one or more signals corresponding to search results, such as receiving one or more search results from one or more other search engine platforms or sending search results to a computing platform or other search engine platforms. In an embodiment, processor 202 may be operable to parse a received search query processing requests at least in part to determine if the requests is an online or an offline query processing request. In addition, embodiment 200 may be operable to transmit a parsed request to one or other components, such as memory queues 210 or 212 for subsequent processing. Furthermore, embodiment 200 may be operable to execute, such as in conjunction with processor 202, a search query processing request at least in part to generate one or more search results, such as search results for an offline or an online search query processing request. Embodiment, 200 may be further operable to store generated search results, such as in a memory cache, for example. It should, however, be noted that these are merely illustrative examples relating to a computing platform and that claimed subject matter is not limited in this regard.

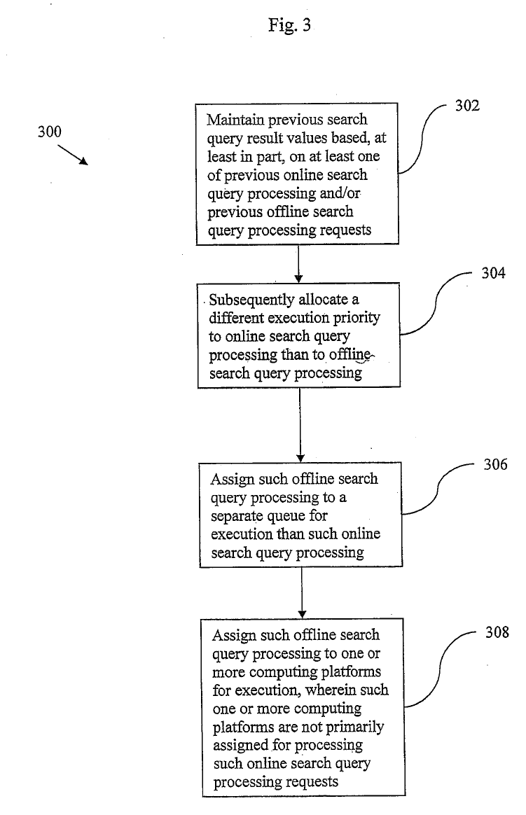

FIG. 3 is a flow chart diagram of a method or process in accordance with an embodiment 300. With regard to box 302, a search engine platform, such as described above with regard to FIGS. 1 and 2, may execute one or more internet search queries. In addition, a search engine platform may maintain previous search query result values based, at least in part, on at least one of previous online search query processing and/or previous offline search query processing requests. For example, a search engine platform may maintain previous search query result values, such as popular search result values in a memory cache for subsequent access and transmission to one or more users. With regard to box 304, a search engine platform may further subsequently allocate a different execution priority to online search query processing than to offline search query processing. For example, offline search query processing requests to update stored internet search query value results may occur when a search engine platform has available resources to execute such queries without unduly hindering execution of online search query processing requests corresponding to user internet search queries. With regard to box 306, a search engine platform may assign such offline search query processing to a separate queue for execution than such online search query processing, such as described above with regard to FIG. 1. For example, a computing platform may parse received requests and determine which queue to place a request in based at least in part on if the request is an offline search query processing request to update stored internet search query result values or an online search query processing request corresponding to a user internet search query. In this example, user internet search queries may be executed at a higher priority than requests to update stored internet search query result values. With regard to box 308, a search engine platform may assign such offline search query processing to one or more computing platforms for execution, wherein such one or more computing platforms are not also assigned primarily for processing such online search query processing requests. For example, a search engine platform may assign user internet search queries to a first group of computing platforms, such as one or more additional search engine platforms, while assigning requests to update stored internet search query result values to a second group of computing platforms, such as one or more other additional search engine platforms that are not primarily processing online search query request. In the above examples, requests to update stored internet search value may be treated differently by a search engine platform than user internet search queries. As discussed above with Regard to FIG. 1 this may be desirable at least in part to allow further refinement of updated stored internet search query values without impacting aspects of providing results for user internet search queries. It should, however, be noted that these are merely illustrative example relating to updating stored internet search values and executing user internet search request and that claimed subject matter is not limited in this regard.

It should be noted that, although aspects of the above system or process may have been described in a particular order, any specific order is merely an example of a process and claimed subject matter is of course not limited to the order described. It should also be noted that the methods and processes described herein, may be capable of being performed by one or more computing platforms. In addition, the methods or processes described herein may be capable of being stored on a storage medium as one or more machine readable instructions, that if executed may enable a computing platform to perform one or more actions. “Storage medium” as referred to herein relates to media capable of maintaining expressions, which may be operated on, or executed by, by one or more machines. For example, a storage medium may comprise one or more storage devices for storing machine-readable instructions or information. Such storage devices may comprise any one of several media types including, for example, magnetic, optical or semiconductor storage media. However, these are merely examples of a storage medium and claimed subject matter is not limited in these respects.

In the preceding description, various aspects of claimed subject matter have been described. For purposes of explanation, specific numbers, systems or configurations were set forth to provide a thorough understanding of claimed subject matter. However, it should be apparent to one skilled in the art having the benefit of this disclosure that claimed subject matter may be practiced without the specific details. In other instances, features that would be understood by one of ordinary skill were omitted or simplified so as not to obscure claimed subject matter. While certain features have been illustrated or described herein, many modifications, substitutions, changes or equivalents will now occur to those skilled in the art. It is, therefore, to be understood that the appended claims are intended to cover all such modifications or changes as fall within the true spirit of claimed subject matter.

1. A method comprising:
maintaining previous search query result values based, at least in part, on at least one of previous online search query processing and/or previous offline search query processing; and
subsequently allocating a different execution priority to online search query processing than to offline search query processing.

2. The method of claim 1, wherein allocating said higher execution priority to said online search query processing than to said offline search query processing comprises:
assigning said offline search query processing to a separate queue for execution than said online search query processing.

3. The method of claim 1, wherein allocating said higher execution priority to said online search query processing than to said offline search query processing comprises:
assigning said offline search query processing to one or more computing platforms for execution, wherein said one or more computing platforms are not primarily assigned for said online search query processing.

4. The method of claim 1, wherein maintaining said previous search query result values comprises at least intermittently initiating said offline search query processing.

5. The method of claim 4, wherein at least intermittently initiating said offline search query processing comprises executing an offline search query for at least one maintained previous search query result value.

6. The method of claim 5, wherein executing said offline search query comprises allocating a set or amount of computation or memory resources to executing said offline search query.

7. The method of claim 6, wherein said first set or amount of computation or memory resources is larger or greater than said second set or amount of computation or memory resources.

8. The method of claim 1, wherein allocating said different execution priority to online search query processing than to offline search query processing comprises allocating a higher execution priority to online search query processing than to offline search query processing.

9. An article comprising: a storage medium having stored thereon instructions that, if executed by a computing platform, enable said computing platform to:
maintain previous search query result values based, at least in part, on at least one of previous online search query processing and/or previous offline search query processing; and
subsequently allocate a different execution priority to online search query processing than to offline search query processing.

10. The article of claim 9, wherein said instructions, if executed by said computing platform, further enable said computing platform to assign said offline search query processing to a separate queue for execution than said online search query processing.

11. The article of claim 9, wherein said instructions, if executed by said computing platform, further enable said computing platform to assign said offline search query processing to one or more computing platforms for execution, wherein said one or more computing platforms are not primarily assigned for said online search query processing.

12. The article of claim 9, wherein said instructions, if executed by said computing platform, further enable said computing platform to maintain said previous search query result values at least in part by intermittently initiating said offline search query processing.

13. The article of claim 12, wherein said intermittently initiating said offline search query processing comprises executing an offline search query for at least one maintained previous search query result value.

14. The article of claim 13, wherein executing said offline search query comprises allocating a set or amount of computation or memory resources to executing said offline search query.

15. An apparatus comprising:
a computing platform;
wherein said computing platform is operable to maintain previous search query result values based, at least in part, on at least one of previous online search query processing and/or previous offline search query processing, and subsequently allocate a different execution priority to online search query processing than to offline search query processing.

16. The apparatus of claim 15, wherein said computing platform is further operable to assign said offline search query processing to a separate queue for execution than said online search query processing.

17. The apparatus of claim 15, wherein said computing platform is further operable to assign said offline search query processing to one or more computing platforms for execution, wherein said one or more computing platforms are not also assigned for said online search query processing.

18. The apparatus of claim 15, wherein said computing platform is further operable to maintain said previous search query result values at least in part by intermittently initiating said offline search query processing.

19. The apparatus of claim 18, wherein executing said offline search query comprises allocating a first set or amount of computation or memory resources to executing said offline search query and a second set or amount of computation or memory resources to executing of said online search query processing.

20. The apparatus of claim 18, wherein intermittently initiating said offline search query processing comprises refining search result values.
